(19) United States
(12) Patent Application Publication
(10) Pub. No.: US 2011/0313934 A1
(43) Pub. Date: Dec. 22, 2011

(54) System and Method for Configuring Workflow Templates

(76) Inventors: Craig Ronald Van Roy, Los Gatos, CA (US); Claudia Rodica Charlier, Gamer, NC (US)

(21) Appl. No.: 13/164,417

(22) Filed: Jun. 20, 2011

Related U.S. Application Data
(60) Provisional application No. 61/356,704, filed on Jun. 21, 2010.

(51) Int. Cl. G06Q 10/00

(52) U.S. Cl. 705/301

(57) ABSTRACT

A system and method for configuring workflow templates is disclosed. In an exemplary embodiment, a server is used to create or edit a workflow template by displaying a plurality of workflow template characteristics, receiving a plurality of workflow template characteristic selections, and storing the workflow template characteristics and associated workflow template characteristic selections in a data storage device so as to define the workflow template. The workflow template specifies a workflow for a plurality of task records associated with a secretary of state or other government agency office. Preferably, the same or a different server is used to assign the task records to workers in the secretary of state or other government agency office by applying the workflow templates to worker profiles.

### CROSS-REFERENCE TO RELATED APPLICATIONS

This application is based on and claims priority to U.S. Provisional Application Ser. No. 61/356,704, filed on Jun. 21, 2010, which is incorporated herein by reference in its entirety.

### STATEMENT REGARDING FEDERALLY SPONSORED RESEARCH OR DEVELOPMENT

Not applicable.

### BACKGROUND OF THE INVENTION

Secretary of state offices and other government agencies perform a variety of tasks on behalf of the general public. The types of tasks handled by such agencies and offices generally relate to liens, business entities, trademarks, notaries, licensing (such as professional and occupational licensing), and other business services. The nature of the task varies depending on the type of task and the processing stage. Typical tasks include reviewing submissions, entering data, approving or verifying documents and other submissions, filling certified document or copy requests, and creating correspondence. Workers are assigned tasks based on their skill level and availability. The software used to permit worker access to documents related to their assigned tasks does not accommodate an office where the number of workers required to complete certain tasks in a timely fashion varies and, thus, does not eliminate backlog in the most efficient manner.

### BRIEF SUMMARY OF THE INVENTION

A method for configuring a plurality of workflow templates used by a secretary of state office is disclosed. In one aspect of the invention, a server is used to create or edit a workflow template by displaying a variety of workflow template characteristics and receiving a user's selection for each workflow template characteristic. The workflow template characteristics and associated workflow template characteristic selections are stored in a data storage device so as to define the workflow template. The workflow template specifies a workflow for a plurality of task records relating to liens, business entities, trademarks, notaries, licensing, and/or other business services.

Preferably, the workflow template is either an access template or a work mode template. An access template specifies one or more task record types to be assigned to a worker. In this case, the workflow template characteristics include an access template designation, one or more office designations (indicating the office in which the access template is used or the office in which the task record originates), an activation date, a deactivation date, one or more task record type characteristics, and an access level. A work mode template specifies the order in which task records are assigned to a worker and whether the task records are continuously assigned to the worker. In this case, the workflow template characteristics include a work mode template designation, a description of the work mode template, a task record priority mode, and a continuous mode option.

In another aspect of the invention, a server is used to manage worker profiles each of which is associated with one or more workers in a secretary of state or similar government agency office performing business services. This is accomplished by displaying a plurality of worker profiles, receiving a selection of worker profiles, displaying the stored workflow templates, receiving a selection of workflow templates, and applying the selected workflow templates to the selected worker profiles. Each worker is then automatically assigned task records in accordance with the workflow templates applied to his/her worker profile.

### BRIEF DESCRIPTION OF THE DRAWINGS

FIG. 1 is a diagram of an exemplary system for creating or editing workflow templates and managing worker profiles.

FIG. 2 is a process flow diagram of an exemplary method for creating or editing workflow templates and managing worker profiles using the system of FIG. 1.

FIGS. 3-5 are exemplary screen shots of the display device of FIG. 1 during the access template configuration process.

FIGS. 6-7 are exemplary screen shots of the display device of FIG. 1 during the work mode template configuration process.

FIGS. 8-11 are exemplary screen shots of the display device of FIG. 1 during the application of workflow templates to worker profiles process.

### DETAILED DESCRIPTION OF PREFERRED EMBODIMENT

The present invention is directed to a method of configuring workflow templates and assigning task records to workers in a secretary of state office or similar government agency office by applying such templates to worker profiles. While the invention will be described in detail below with reference to an exemplary embodiment, it should be understood that the invention is not limited to the specific system configuration or methodology of this embodiment. In addition, although the exemplary embodiment is described as embodying several different inventive features, one skilled in the art will appreciate that any one of these features could be implemented without the others in accordance with the invention.

Each worker is trained to review or process one or more types of task records. As used throughout the specification and claims, the term “task record” means any object that is created, stored, processed, tracked, or otherwise accounted for in an office or organization and that requires some level of review or processing, including but not limited to data entry, indexing, verification, or generation of responsive correspondence. Examples of task records include filed documents or work items; documents or work items received from third parties, including but not limited to applications for registration and requests for certified copies; and documents or work items generated while processing or tracking another object in the system, such as invoices, orders, receipts, billing statements, and receivable statements, as well as documents or work items related to the secretary of state office's or other government agency's role in performing business entity, lien, trademark, notary, and professional and occupational licensing services. Each task record may be subject to multiple review or processing steps. For instance, a task record may require one or more verification steps, each of which is completed by the same worker or different workers.

Task records can be categorized by a variety of different task record type characteristics, including the line of business to which the task records relate (such as business entity, trademark, notary, licensing, and other business services such as requests for certified copies), tiling category (such as initial, amendment, or correction), processing stage (such as rejected to be imaged, re-scan, to be indexed, to be verified, application examination, and correspondence to be generated), priority indicator (such as urgent, next day, or other priority levels), office designations indicating where the task record originated or will be processed, one or more task record names (such as UCC1, annual report, trademark description, notary name, or notary address), or the task record group to which a filing belongs (such as UCC, Federal Tax Lien, Custom Lien, LLC, Non-Profit, or Service Mark). Depending on the time of year or changes in the regulations, a secretary of state office may be inundated with a particular type of task record during a particular period of time.

Any given worker's workflow is defined in part by the type of task record(s) assigned to the worker and the level of access a worker has for a particular type of task record, i.e., the actions a worker may take with respect to that task record such as view, edit, or none. Workflow is also defined by a work mode, such as a continuous mode in which a worker is automatically presented with the next task record on which to work or a priority mode whereby the task records are ordered according to the priority level. Examples of priority modes are “oldest task record only,” “oldest task record in [line of business],” “priority only,” “priority level [x] only,” “expedited only,” etc. The present invention allows a user to manage a worker's workflow using workflow templates. Workflow templates, such as access templates and work mode templates, are configured and stored such that they are available for application to worker profiles. By applying workflow templates to one or more worker profiles and/or activating and deactivating certain workflow templates for a particular worker profile, the work may be efficiently and dynamically distributed among a group of workers in the office to eliminate backlog and prevent any workers from running out of task records.

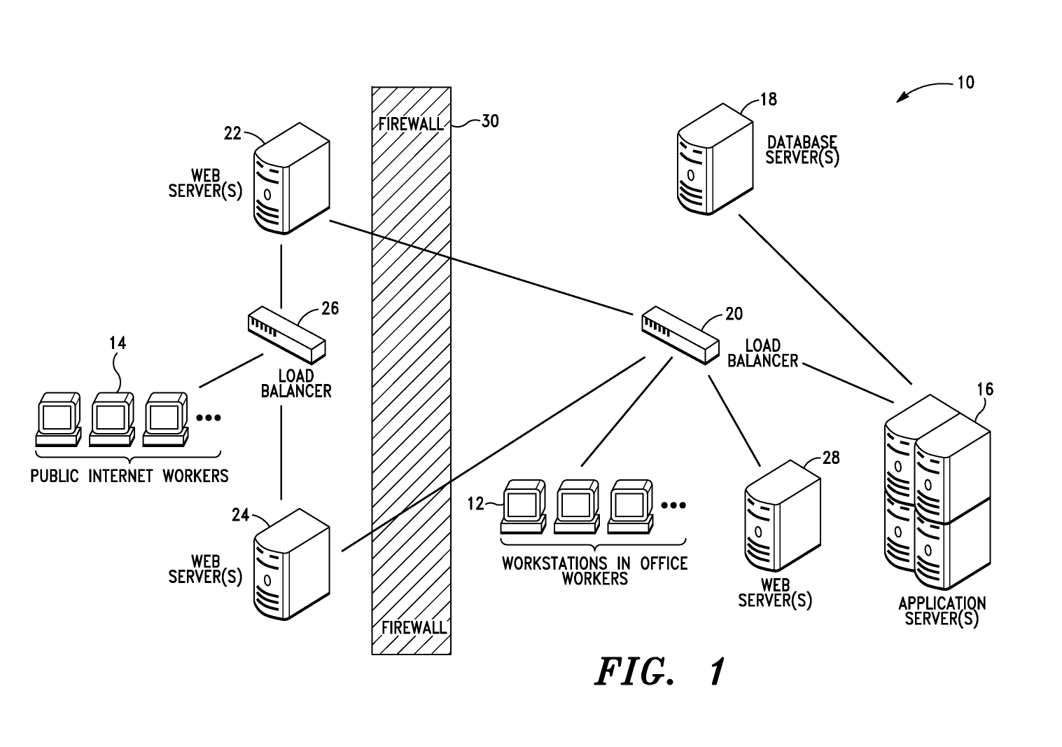

Referring to FIG. 1, an exemplary system used to configure workflow templates and apply them to one or more worker profiles in accordance with the present invention is shown generally as reference numeral 10. System 10 includes one or more workstations 12 for use by workers located in an office, such as a secretary of state office or similar government agency office. Workstations 12 may comprise any suitable computing system (such as a programmed general purpose computer, a special purpose computer, or the like). One or more peripheral devices may also be provided, such as a display device, a standard keyboard, a mouse, a scanner, a barcode reader for scanning the barcode on a paper filing or other paper document, a magnetic stripe reader for scanning identification or access cards (such as worker identification/access cards used for security purposes), and/or a printer for printing a paper filing or other task record stored in the system. System 10 also includes computers 14 used by external workers or other users who are permitted to access the system from a remote location using public Internet and VPN technologies known in the art.

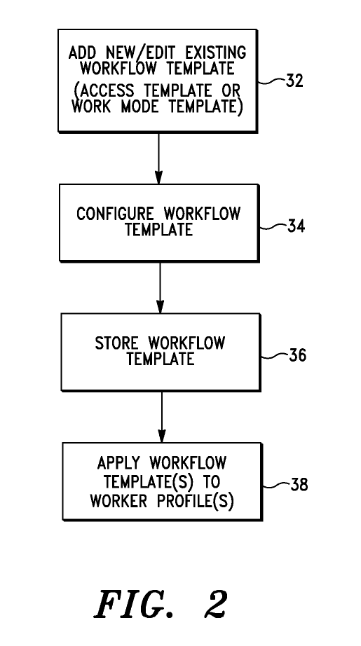

System 10 also includes one or more centralized application servers 16 each of which hosts and runs one or more applications in accordance with the present invention. One application server is used to configure workflow templates; as described below in connection with FIGS. 2-7. The same application server or another application server is used to apply workflow templates to worker profiles, as described below in connection with FIGS. 2 and 8-11. For simplicity, the term “application server” as used herein means both the hardware (i.e., any computing device in which a processor is operable to execute computer-readable instructions stored on a computer-readable medium) and the application(s) that reside thereon.

System 10 further includes one or more centralized database servers 18 each of which stores various types of data, such as workflow templates, task records, and worker profiles. For simplicity, the term “database server” as used herein means both the hardware (i.e., any data storage device or memory operable to store and provide access to data) and the data stored therein. It should be understood that the data may be stored in a database or any other type of data storage structure known in the art. For example, all or a portion of the data may be stored as a variable on the system in files of various types, such as XML files, flat files, fixed length files, delimited files, batch files, application configuration files, and a wide variety of other file types known in the art.

Several types of computer network connections may be used to network the various components of system 10, including a local area network (LAN), a wide area network (WAN), and other network topologies known in the art. In the illustrated example, a load balancer/router 20 functions to route network traffic between workstations 12 and application servers 16 and database servers 18. In addition, remote computers 14 located outside of the network may access the application servers 16 and database servers 18 through external web servers 22 and 24 and a load balancer/router 26 that are connected to an internal web server 28 through any suitable firewall 30. Alternatively, remote computers 14 could access application servers 16 and database servers 18 directly through firewall 30 (via an appropriate network configuration), through a series of external web servers, through a VPN connection, or through any other technologies known in the art.

System 10 described above and shown in FIG. 1 is merely an example of a network architecture that may be used to implement the present invention. One skilled in the art will understand that other network architectures may also be used, including a more decentralized model in which the application server(s) and/or database server(s) are only accessible from specific workstations or where the functionality is distributed so that it actually resides on the client workstations in a client application type of model. Also, the application servers and database servers may be replaced with one or more servers that perform both the application and data storage functions described above. Thus, the system may be implemented with any number of servers without departing from the scope of the present invention.

Task records are created and updated in a number of ways depending on how the information is received or processed. For example, a trademark application may be submitted online through a web-based filing or processing system. The applicant initially provides certain information, such as the applicant's name, the applicant's residence address, and the proposed trademark. When the application is submitted, a task record for that application is created and stored in database server(s) 18. In this example, the task record type characteristics include, among others, the line of business, i.e., trademark, and the filing category, i.e., initial. The application task record also includes the information initially entered by the applicant and may include additional information generated at the time of submission, such as a unique application number and filing date.

The initial trademark task record may first be assigned to a worker for review to determine whether the application is complete. Once that worker is finished, the task record may be assigned or otherwise made available to the same or a different worker with an appropriate worker profile to generate correspondence to the applicant confirming that the application was received. Information about that correspondence, such as the date and time sent, may be stored in association with the application task record. The application task record may next be examined by the same or a different worker who has been trained to determine whether a trademark is appropriate for registration under the applicable laws and regulations. Once examination is complete, further information may be added to the task record such as a registration number or final notification information indicating registration or rejection. Much of the information described above may be automatically generated and added to the task record as it progresses through the various processing stages. Some information may be manually entered by a worker who has edit access to that particular type of task record.

It should be understood that the above example is provided only for the purpose of illustrating the way a type of task record may be created and assigned to various workers in accordance with how the workflow templates are configured and applied to worker profiles, as described below. One skilled in the art will understand that the task record type characteristics and the processing stages will vary depending on the task record at issue.

Referring now to FIG. 2, a process flow diagram that shows an exemplary method of configuring workflow templates and applying them to one or more worker profiles using system 10 of FIG. 1 is provided. Preferably, workflow templates are initially configured by a supervisor so that each template is configured to best suit a particular office's needs. The supervisor also applies the workflow templates to the worker profiles as desired. In some circumstances, a worker may be allowed to modify her own worker profile either manually or by using the workflow templates. In other circumstances, a worker may have more than one worker profile and each profile may be activated or deactivated by a senior manager. In this way, the level of control for delegating work is customizable to the needs of the office using system 10.

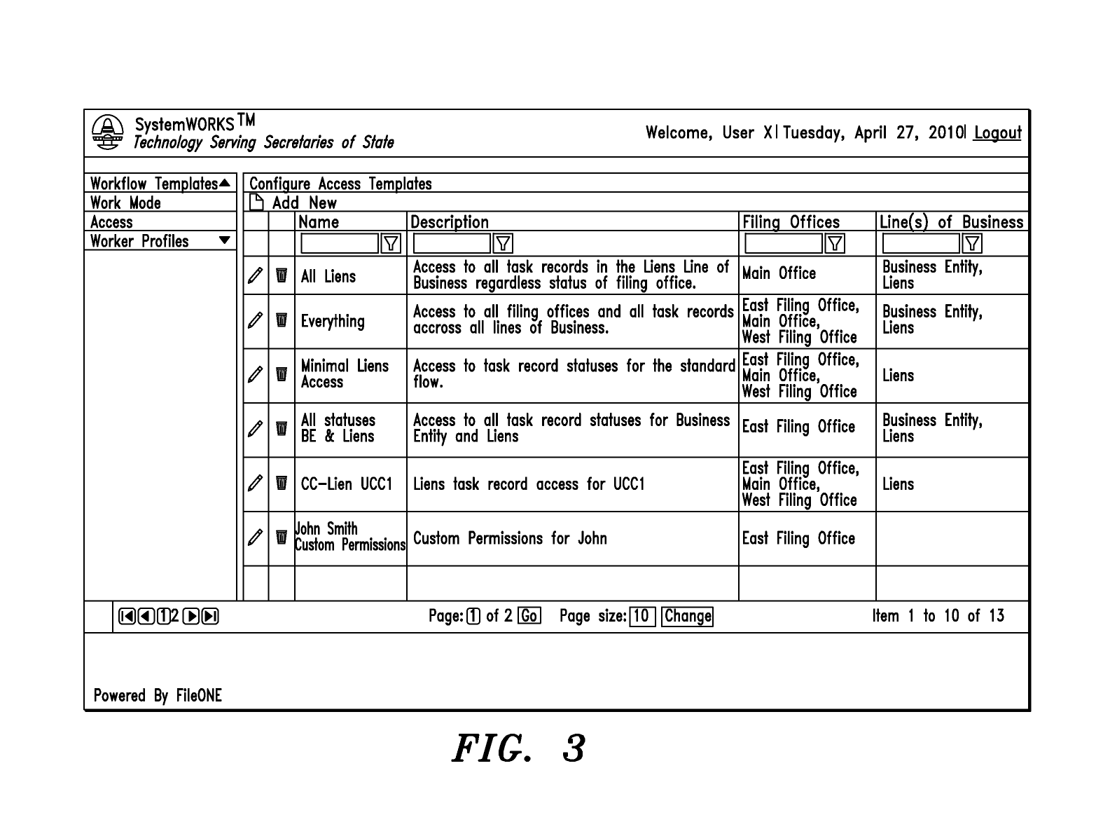

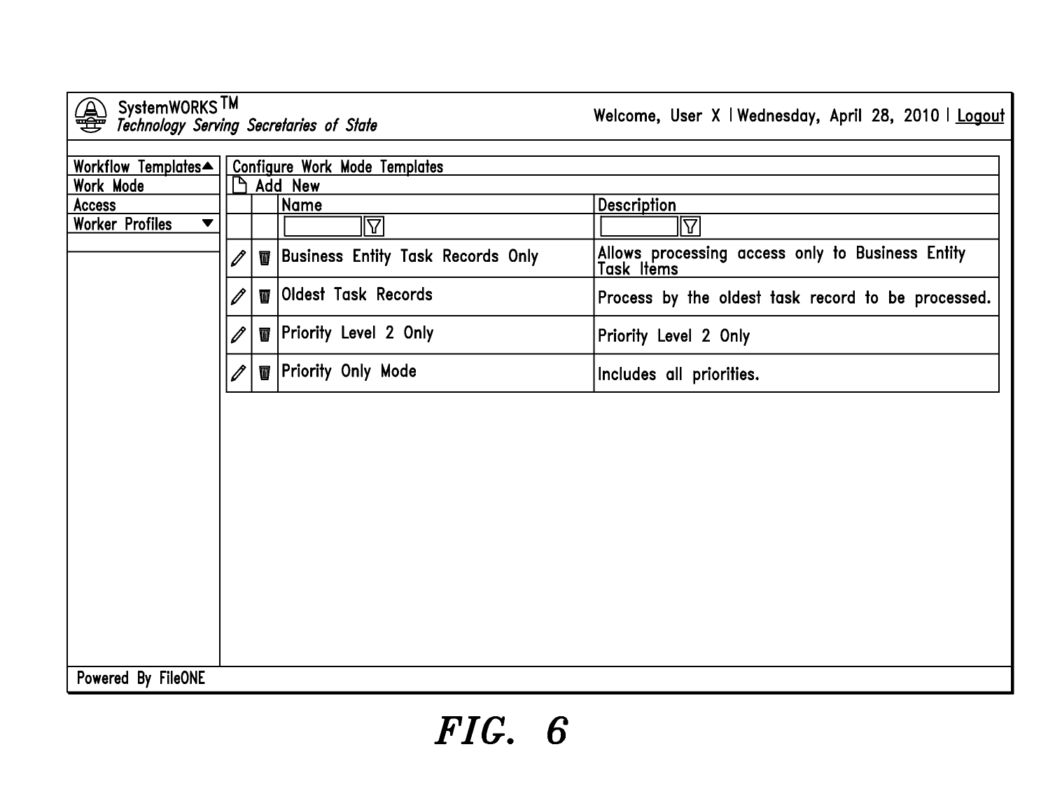

With reference to FIG. 2 at block 32, the software residing on application server(s) 16 presents a user interface that enables the user (e.g., via one of workstations 12 or remote computers 14) to add a new workflow template to database server(s) 18 or edit an existing workflow template stored in database server(s) 18. An exemplary “Configure Access Templates” summary screen that is displayed on the user's display screen is shown in FIG. 3 and an exemplary “Configure Work Mode Templates” summary screen that is displayed on the user's display screen is shown in FIG. 6. Both summary screens list the access templates and work mode templates currently stored in database server(s) 18 in conjunction with several of the workflow characteristics and corresponding workflow characteristic selections as defined below. Of course, it should be understood that the summaries may include any or all of the workflow template characteristics associated with the workflow template selections stored on database server(s) 18.

From the screens shown in FIGS. 3 and 6, the user may choose to create a new workflow template by selecting an “Add New” button or edit an existing workflow template by selecting an “Edit” button associated with the existing template. The user may also delete a workflow template by selecting a “Delete” button. The term “button” in this context and as the term is used throughout the specification, refers to any shape, including word phrases, a pencil shape, or recycle bin shape, that is capable of being actuated by the user to execute the desired feature. Alternatively, any other method known in the art such as a hyperlink, voice command, or set of keyboard commands may be used to execute the desired feature.

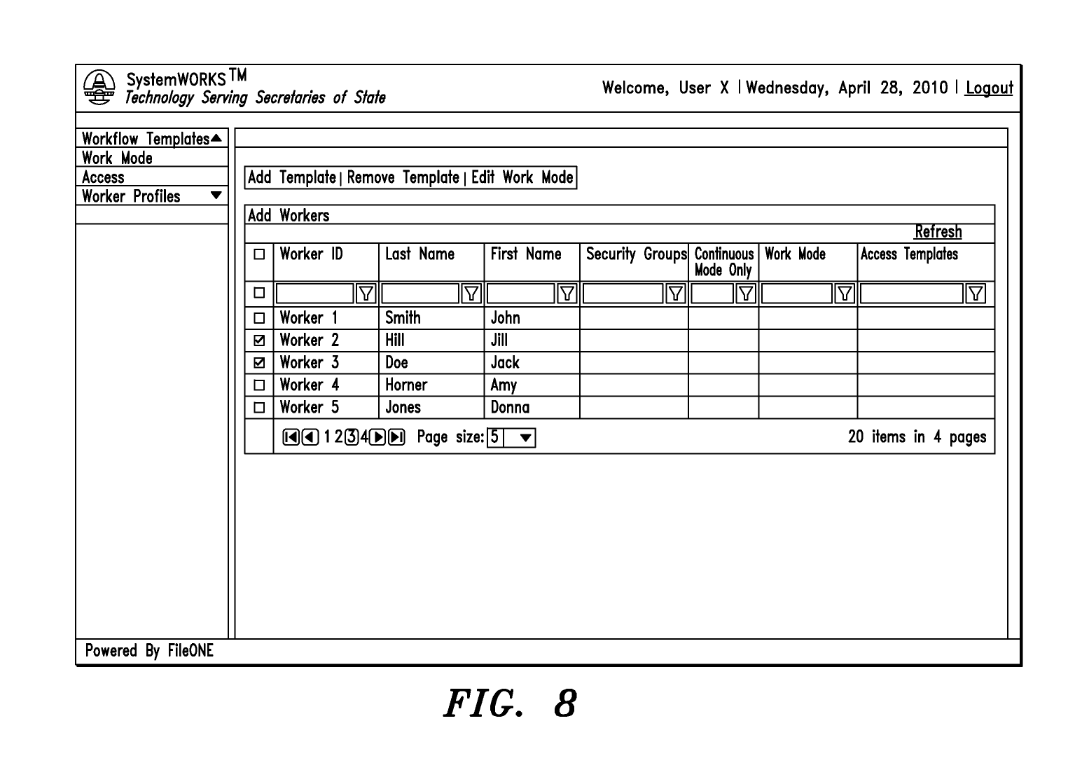

When the user creates a new workflow template or edits an existing workflow template, she makes selections for various workflow template characteristics. With reference to FIG. 2 at block 34, the user may configure a new access template by making selections for workflow template characteristics such as an access template designation, one or more office designations (such as the office in which the template will be used or from which the task record originates), an activation date, a deactivation date, one or more task record type characteristics, and an access level. The user may similarly configure a work mode template by making selections for workflow template characteristics such as a work mode template designation, a description of the work mode template, a task record priority mode, and a continuous mode option. It should be understood that any method known in the art for displaying any of the workflow template characteristics and receiving workflow template characteristic selections may be used. For example, a workflow template characteristic may be displayed in association with a text box, in which case the selection is a text entry entered by a user in the text box (as described below with reference to the workflow template name/designation and description). A workflow template characteristic may also be displayed in association with a checkbox, in which case the selection is a check entered by a user in the checkbox (similar to what is described below with reference to selecting worker profiles in FIG. 8). In addition, a workflow template characteristic may be displayed in association with one or more pre-determined options, in which case the selection is a selection made by a user form the pre-determined options (as described below with reference to the filing office options). Other selection methods may include marking a radio button, actuating a button, or selecting indicators such as “yes” or “no,” or “on” or “off” for each workflow template characteristic.

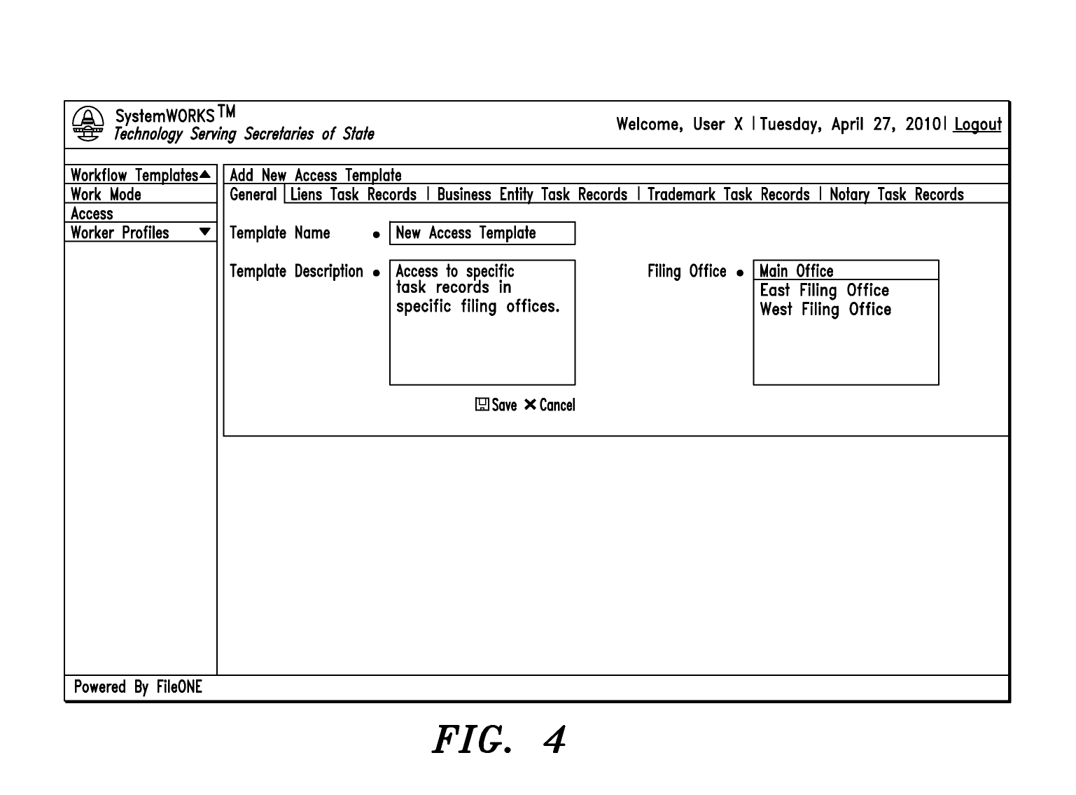

An exemplary “Add New Access Template—General” screen that is displayed on a user's display screen is shown in FIG. 4. As can be seen, the user makes workflow template characteristic selections for the access template name/designation, the access template description, and the filing office. Other aspects of a worker's workflow may be configured at this point if the appropriate characteristic is provided on a screen (such as the one shown in FIG. 4) in conjunction with a method for receiving a workflow characteristic selection. These additional characteristics may relate to access to task records having a certain priority level (i.e., standard, rush, expedite, etc.; level 1, 2, 3, etc.; 2-hour, 4-hour, 1-day, etc.), dates during which the access template is active or a date the access template is automatically activated or deactivated, and the hierarchy among templates in the event the access permitted by one template conflicts with the access permitted by another template also assigned to a worker profile.

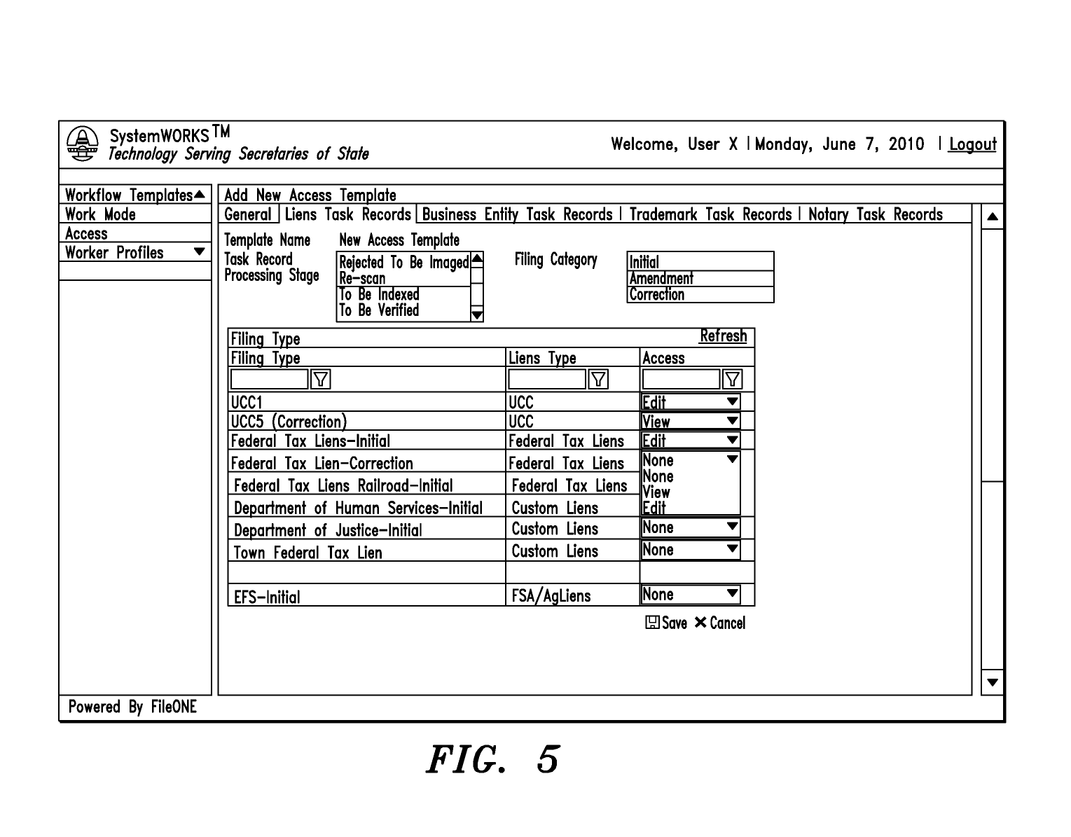

The user further configures the access template by selecting a line of business tab. As shown in FIG. 4, line of business tabs, including but not limited to “Liens Task Records,” “Business Entity Task Records,” “Trademark Task Records,” and “Notary Task Records” are provided depending on the nature of the business conducted by the office(s) using system 10. In this way, access templates may be configured at a level of detail that is meaningful to each participating office or organization in that they can be focused on a particular subset of task records where there is backlog of tasks to be performed. An exemplary “Add New Access Template—Liens Task Records” screen that is displayed on the user's display screen after selecting the “Lien Task Records” line of business tab is shown in FIG. 5. This screen displays various task record type characteristics relating to processing lien task records and the access level for each task record type. As can be seen, the task record type characteristics include task record processing stage, filing category, and names or other identifiers for specific task records and groups.

Task record processing stage refers to the status of the task record during processing and review. In general, task records pass through several phases during processing and review, including but not limited to an intake phase (such as initial data entry and task record generation), a scanning and reconciliation phase (where, for example, the related documents are scanned in and the image is connected with its task record), and one or more processing and correspondence generation phases (where, for example, the underlying filing or request is reviewed and then accepted, rejected, or completed; marked as such, for example, with an official seal if accepted; and appropriate correspondence such as a certificate, acknowledgement letter, or rejection letter is generated). As indicated above, within each phase there may be multiple processing/review stages. Each stage may be performed by the same or different workers. As shown in FIG. 5, a scrolling menu box listing the various processing stages for a lien task record is provided and includes stages such as “rejected to be imaged,” “re-scan,” “to be indexed,” and “to be verified.” Other examples of processing stages are “rejected to be scanned,” “to be imaged/scanned,” “rejected,” “filed,” “suspended,” “hold,” “pending,” “supervisor/manager review.” “to be examined,” “to be processed.” and “reject review.” By selecting one or more stages for this task record type characteristic, the user configures the access a worker has to task records at that stage in the processing/review process. As shown in FIG. 5, the user has chosen task records with a status of “to be indexed” and “to be verified.” Thus, a worker's access to certain categories of lien task records in need of indexing and verification may be configured in this template as described below.

Filing category refers to the category of lien task records the user wants to specifically permit access to using this template. As shown in FIG. 5, filing categories for lien task records include “initial,” “amendment,” and “correction.” Other examples of filing or request categories include “initial,” “creation,” “renewals,” “mergers,” “withdrawal,” “conversion,” “dissolution,” “annual/periodic reports,” “assignments,” “division,” “consolidation,” “name reservation,” and “name registration.” Each filing/request category corresponds to a subset of task records within a line of business that are stored in system 10.

Once the task record processing stage and filing category characteristic selections have been received, a table, such as the “Filing Type” table shown in FIG. 5, is automatically populated with all the available task record types. At this point the user selects the level of access she wishes to grant a worker for each type of task record. For example, the user may choose “Edit” for UCC1 task records for UCC liens, “View” for UCC5 (Correction) task records for UCC and “None” for Federal Tax Lien—Correction task records for Federal Tax Liens. As such, the worker will not have access to any Federal Tax Lien—Correction task records, will be able to view but not edit UCC5 (Correction) task records, and will be able to view and edit UCC1 task records.

With reference to FIG. 2 at block 36, the access template is stored once the user has configured all the desired characteristics. As shown in FIGS. 4 and 5, system 10 stores the template in database server(s) 18 after the user selects a “save” button, such as a disc icon. Alternatively, the user may select a “cancel” button, such as an “X” icon, if she decides not to save the template as configured.

With reference to FIG. 2 at blocks 32 and 34, the user may alternatively choose to edit an existing access template. To do so, the user must select an edit button associated with the desired template, such as a pencil icon as shown in FIG. 3. When editing an existing access template, the workflow template characteristic selections for that particular template are displayed in a format similar to the one shown in FIGS. 4 and 5. The user makes the appropriate edits and then selects a “save” button to cause her changes to be stored. Any changes to a template that has already been applied to one or more worker profiles (as described below) will be automatically reflected in those profiles. In other words, if the access level for UCC1 task records is changed in the access template shown in FIG. 5 from “Edit” to “None,” then all workers associated with worker profiles to which this template was applied would not be able to view or edit UCC1 task records once the change to the access template has been stored. Likewise, the user may cause her changes to be cancelled by selecting a “cancel” button, such as an “X” icon as shown in FIGS. 4 and 5. A user may also cause a template to be deleted by selecting a button, such as a recycle bin icon, associated with the access template desired to be deleted as shown in FIG. 3. The user may also have the option to cause the template to be deactivated or locked, i.e., to prevent any editing of the template by another user, by selecting an appropriate button (not shown).

With reference, to FIG. 2 at block 32, the software residing on application server(s) 16 presents a user interface that enables the user (via one of workstations 12 or remote computers 14) to either add a new work mode template to database server(s) 18 or edit an existing work mode template stored in database server(s) 18. An exemplary “Configure Work Mode Templates” summary screen that is displayed on the user's display screen is shown in FIG. 6. This screen provides a list of work mode templates currently stored in database server(s) 18. Summary information about each work mode template, including but not limited to the template name and description, is provided.

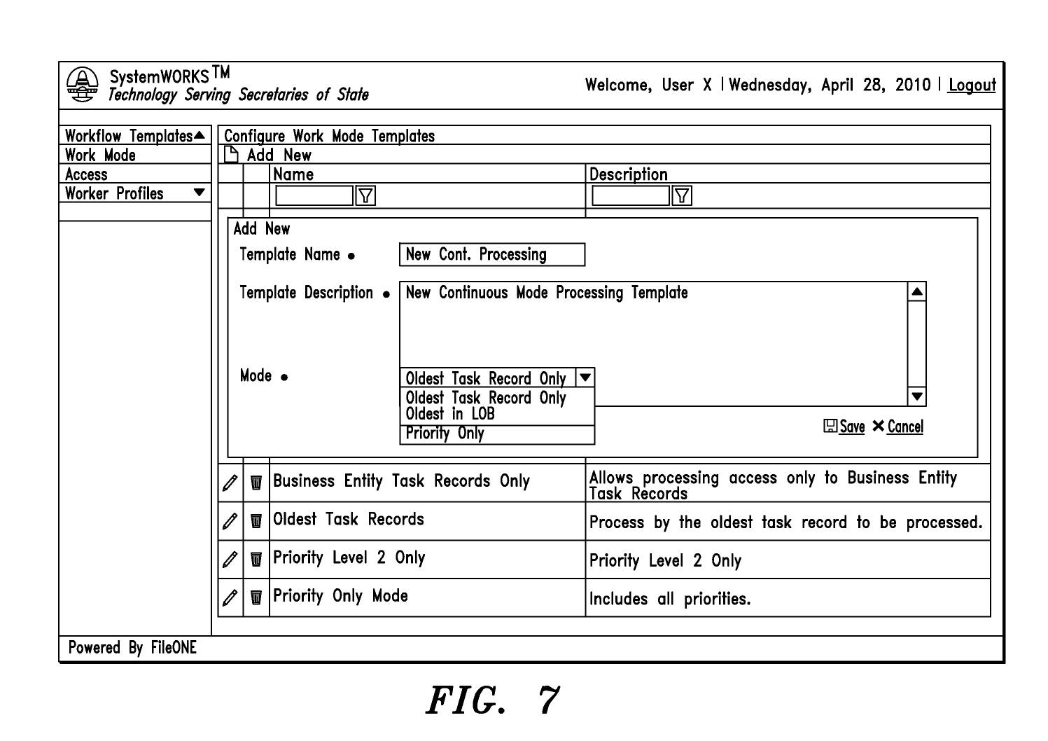

With reference to FIG. 2 at block 34, a user configures a new work mode template by selecting the appropriate button. As previously discussed, a work mode template determines how a user is presented with the next task record on which to work. For example, the work mode may be “continuous,” in which case a worker is automatically presented with each successive task record on which to work. An exemplary “Configure Work Mode Template—Add New” screen displayed on a user's display screen is shown in FIG. 7. As shown in FIG. 7, configuring a new work mode template requires receiving selections for each of the workflow template characteristics, including the name of the template and the template description. Additional workflow template characteristics may also be provided that allow the user to configure when the template is active. Configuring the new work mode template also comprises receiving a selection for the task record priority mode, which dictates the order in which the worker is to complete the task records. As shown in FIG. 7, optional modes may be based on the following or any combination of the following: date received. i.e., “oldest item only;” date received and line of business. i.e., “oldest in LOB:” priority level, i.e., “priority only” or “priority—[processing deadline (1-hour, 2-hour, 1-day, etc.), level (1, 2, 3, etc.), or other priority descriptor (standard, rush, expedite, etc.)];” or queue number. Multiple modes may be selected, for example “priority—2-hour” and “priority—4-hour” may both be selected such that all priority task records requiring a two-hour or four-hour processing time will be included in the workflow for a worker whose worker profile includes a work mode template so configured.

When more than one work mode is selected, conflicts between modes may be resolved by relating the modes to one another in a hierarchical fashion. For instance, priority level may take precedence over dates, and dates may take precedence over queue number. Within each work mode, task records may be prioritized according to level, chronological or reverse chronological order, or ascending or descending numerical order. In addition, the priority mode may be limited to a particular line of business or task record type such that only task records in the selected line of business or only the selected task record types are automatically presented to the worker via the mode selected. All other task record types or task records in other lines of business that the worker has access to pursuant to her worker profile would be available for manual selection.

With reference to FIG. 2 at block 36 and FIG. 7, the user causes the template to be stored in database server(s) 18 by selecting a “save” button, such as a disc icon. Alternatively, the user may select a “cancel” button, such as an “X” icon, if she decides not to save the template as configured.

With reference to FIG. 2 at blocks 32 and 34, the user may alternatively choose to edit an existing work mode template by selecting an edit button associated with the desired template, such as a pencil icon as shown in FIG. 6. If the user chooses to edit an existing work mode template, the workflow template characteristic selections for that particular template are displayed in a format similar to the one shown in FIG. 7. The user may make the appropriate edits and then cause the revised template to be stored by selecting a “save” button. Again, any changes saved to a template that has already been applied to one or more worker profiles will be automatically reflected in the workflow for those workers. In other words, if a work mode template was previously configured as “priority only,” but was edited to be “oldest task record only.” all workers associated with worker profiles to which that template was applied would then be presented with the oldest task record in the queue instead of priority task records. Likewise, the user may cancel her changes to a template by selecting a “cancel” button, such as an “X” icon as shown in FIG. 7. A user may also cause a template to be deleted by selecting a button, such as a recycle bin icon, associated with the template desired to be deleted as shown in FIG. 6. The user may also have the option to cause the template to be deactivated or locked. i.e., to prevent any editing of the template by another user, by selecting an appropriate button (not shown).

With reference to FIG. 2 at block 38, once workflow templates have been configured and stored in database server(s) 18 of system 10, they may be applied to one or more worker profiles. An exemplary “Configure User Access” screen that is displayed on a user's display screen is shown in FIG. 8. As can be seen, all worker profiles are displayed in a table and identified by any combination of the worker's ID, first name, last name, or any other unique identifier. Alternatively, the workers may be filtered by entering various criteria in the field provided and selecting the associated button, such as the funnel icon shown in FIG. 8. Additional information regarding the current status of each worker's permission profile may also be provided. As shown in FIG. 8, this information includes security groups, whether the worker must operate only under the assigned work mode template where the worker receives task records in an automatic, continuous fashion, the name of the work mode template(s) assigned, and the name of the access template(s) assigned. From this screen, the user may select which worker profiles to edit. As shown in FIG. 8, this is accomplished by providing a check box next to each worker profile. Alternative methods for selecting workers may include a drop down menu, yes/no buttons, or any other method known in the art for receiving user selections. After selecting the workers, the user has the option of adding an access template, removing an access template, or editing the work mode template by selecting an appropriate button. As shown in FIG. 8, buttons such as “Add Template,” “Remove Template,” and “Edit Work Mode” are presented.

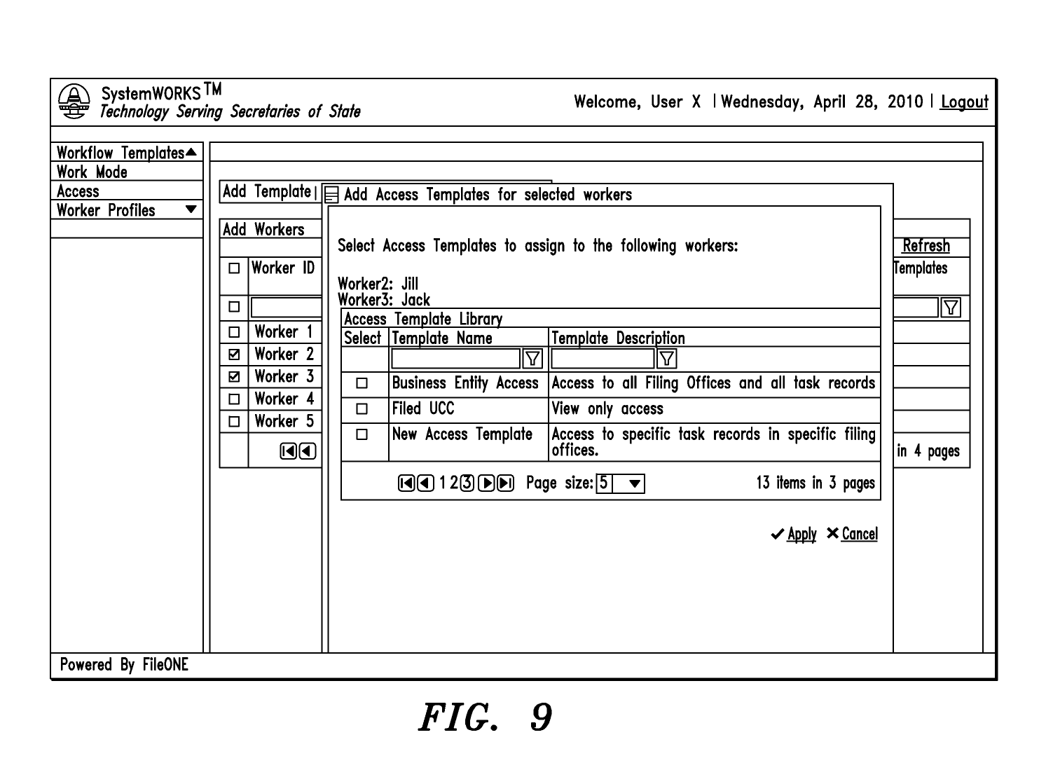

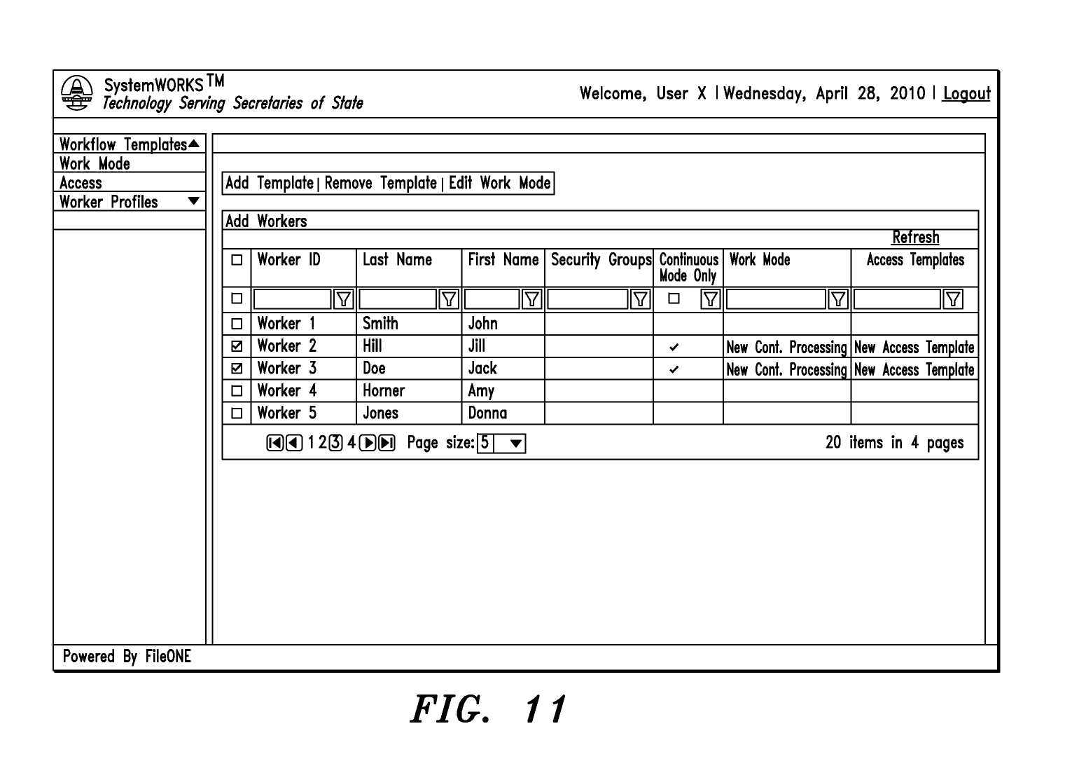

An exemplary “Add Access Template for Selected Workers” screen that appears on the user's display screen once the “Add Template” button is selected is shown in FIG. 9. This screen displays a list of the selected worker profiles and a list of workflow templates that could be added to the selected worker profiles. A similarly structured screen is displayed if the “Remove Template” button is selected. The user then selects which templates to add or remove from the selected worker permission profiles. As shown in FIG. 9, this is accomplished by providing a check box next to each of the available templates. Alternative methods for selecting templates include a drop down menu, yes/no buttons, or any other method known in the art for receiving operator preferences. Additionally, dates during which the template is active for the selected worker profiles (or conversely, an expiration date) are also configured by providing the appropriate characteristic and method for receiving a user selection. After the templates to be added or removed have been selected, system 10 will apply (or remove) the selected workflow templates to the selected worker profiles after the user selects an apply button, such as the checkmark “Apply” icon shown in FIG. 9. The system then notifies the user that the appropriate changes have been successfully made. The applied changes are then reflected in the table of workers. For example, if Worker 2 and Worker 3 are assigned the “New Access Template,” as shown in FIG. 9, then “New Access Template” will appear in the access template column of the worker profile table as shown in FIG. 11. Alternatively, the user may decide not to have the system apply any changes and select a cancel button instead.

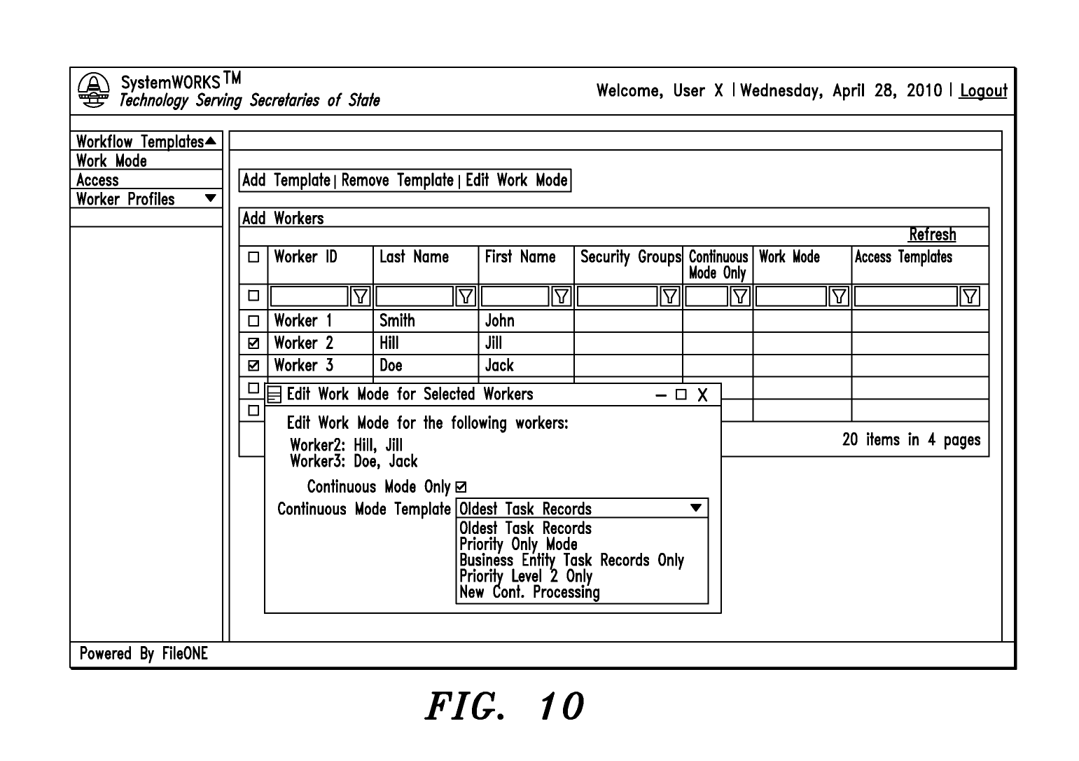

To edit the work mode template, the user selects the “Edit Work Mode” button. An exemplary “Edit Work Mode for Selected Workers” screen that appears on a user's display screen after the “Edit Work Mode” button has been selected is shown in FIG. 10. This screen displays a list of the selected worker profiles, presents a list of available work mode templates, and presents the option of only allowing the user to operate under the work mode template assigned. If no work mode template is assigned for a particular worker, the worker must manually select the next task record on which to work out of all task records to which the worker has access. If a work mode template is assigned to a worker and the option to only allow the worker to operate under the assigned work mode is activated, such as by checking the box next to “Continuous Mode Only” in FIG. 10, the worker is automatically presented with the next task record on which to work and will not be able to manually choose a task record on which she wants to work. If a work mode template is assigned to a particular worker but the option to only allow the worker to operate under the assigned work mode, i.e., the continuous mode, is not activated, the worker will have the option to work under the work mode assigned or manually select the next task record on which to work. Alternative methods for activating/deactivating the work mode only feature include yes/no or on/off buttons or any other method known in the art for communicating operator preferences. Additionally, dates during which the template is active for the selected worker profiles (or conversely, an expiration date) may also be configured by providing the appropriate workflow template characteristic and method for receiving a workflow template characteristic selection. Of course a default work mode template may be initially assigned to all workers added to the system.

As shown in FIG. 10, the user has selected the continuous mode only option by checking the appropriate box and has selected a work mode template from a drop down menu. The user may cause her changes to be applied by selecting the appropriate button, such as a checkmark “Apply” button (not shown). A message notifying the user that the appropriate changes have been successfully made is then presented. Again, the changes made are reflected in the table of worker profiles. For example, if the “New Cont. Processing” work mode template has been assigned to Worker 2 and Worker 3 and the option to only allow those workers to operate under the assigned work mode, i.e., the continuous mode, has been activated, as shown in FIG. 10, then a checkmark or other indicator will appear in the work mode only column, i.e., the “Continuous Mode Only” column, of the worker profile table and “New Cont. Processing” will appear in the work mode column as shown in FIG. 11. Alternatively, the user may decide not to have her changes applied and select a cancel button (not shown) instead.

While the present invention has been described and illustrated hereinabove with reference to an exemplary embodiment, it should be understood that various modifications could be made to this embodiment without departing from the scope of the invention. Therefore, the invention is not to be limited to the exemplary embodiment except insofar as such limitations are included in the following claims.

1. A computer-implemented method for configuring one or more workflow templates used by a secretary of state or other government agency office, comprising:
providing a data storage device for storing at least one workflow template that specifies a workflow for a plurality of task records selected from the group consisting of lien task records, business entity task records, trademark task records, notary task records, and licensing task records;
using a server to create or edit said workflow template, wherein said server is operable to:
display a plurality of workflow template characteristics;
receive a plurality of workflow template characteristic selections corresponding to said workflow template characteristics; and
store said workflow template characteristics and workflow template characteristic selections in said data storage device so as to define said workflow template.

2. The computer-implemented method of claim 1, further comprising:
providing a second data storage device for storing at least one worker profile associated with at least one worker; and
using a second server to edit said worker profile, wherein said second server is operable to apply said workflow template to said worker profile whereby said task records are assigned to said worker associated with said worker profile in accordance with said workflow template.

3. The computer-implemented method of claim 2, wherein said data storage device and said second data storage device comprise a single data storage device.

4. The computer-implemented method of claim 2, wherein said server and said second server comprise a single server.

5. The computer-implemented method of claim 1, wherein said workflow template comprises an access template that specifies one or more task record types to be assigned to a worker.

6. The computer-implemented method of claim 5, wherein said workflow template characteristics comprise one or more of the following: an access template designation, one or more office designations, a description of said access template, a line of business in which said access template is used, an activation date, a deactivation date, one or more task record type characteristics, and an access level.

7. The computer-implemented method of claim 1, wherein said workflow template comprises a work mode template that specifies an order in which said task records are assigned to a worker and whether said task records are continuously assigned to said worker.

8. The computer-implemented method of claim 7, wherein said workflow template characteristics comprise one or more of the following: a work mode template designation, a description of said work mode template, a task record priority mode, and a continuous mode option.

9. The computer-implemented method of claim 1, wherein said server is further operable to display one or more pre-determined options associated with at least one of said workflow template characteristics.

10. The computer-implemented method of claim 9, wherein at least one of said workflow template characteristic selections comprises a selection made by a user from said pre-determined options.

11. The computer-implemented method of claim 1, wherein said server is further operable to display a text box associated with at least one of said workflow template characteristics.

12. The computer-implemented method of claim 11, wherein at least one of said workflow template characteristic selections comprises a text entry entered by a user in said text box.

13. The computer-implemented method of claim 1, wherein said server is further operable to display a checkbox for at least one of said workflow template characteristics.

14. The computer-implemented method of claim 13, wherein at least one of said workflow template characteristic selections comprises a check entered by a user in said checkbox.

15. The computer-implemented method of claim 1, wherein said server is further operable to display a summary of said workflow template.

16. The computer implemented method of claim 15, wherein said summary of said workflow template comprises one or more of said workflow template characteristics and associated workflow template characteristic selections for said workflow template.

17. A computer-implemented method for assigning task records to workers in a secretary of state or other government agency office, comprising:
providing a data storage device for storing (i) a plurality of worker profiles each of which is associated with at least one worker and (ii) a plurality of workflow templates each of which specifies a workflow for a plurality of task records selected from the group consisting of lien task records, business entity task records, trademark task records, notary task records, and licensing task records;
using a first server to create or edit said workflow templates, wherein said first server is operable to:
display a plurality of workflow template characteristics;
receive a plurality of workflow template characteristic selections corresponding to said workflow template characteristics;
store said workflow template characteristics and said workflow template characteristic selections in said data storage device so as to define one of said workflow templates;
using a second server to manage said worker profiles, wherein said second server is operable to:
display said worker profiles stored in said data storage device;
receive a selection of one or more of said displayed worker profiles;
display said workflow templates stored in said data storage device;
receive a selection of one or more of said displayed workflow templates; and
apply said selected workflow templates to said selected worker profiles.

18. The computer-implemented method of claim 17, wherein said first server and said second server comprise a single server.

19. The computer-implemented method of claim 17, wherein said task records are assigned to each said worker associated with said selected worker profiles in accordance with said applied workflow templates.

20. The computer-implemented method of claim 17, wherein said second server is further operable to display said applied workflow templates in association with each of said worker profiles.

21. The computer-implemented method of claim 17, wherein said second server is further operable to remove one or more of said applied workflow templates from one or more of said worker profiles.

22. The computer-implemented method of claim 17, wherein one of said applied workflow templates comprises an access template that specifies one or more task record types to be assigned to each said worker associated with said selected worker profiles.

23. The computer-implemented method of claim 22, wherein said workflow template characteristics comprise one or more of the following: an access template designation, one or more office designations, a description of said access template, a line of business in which said access template is used, an activation date, a deactivation date, one or more task record type characteristics, and an access level.

24. The computer implemented method of claim 17, wherein one of said applied workflow templates comprises a work mode template that specifies the order in which said task records are assigned to each said worker associated with said selected worker profiles and whether said task records are continuously assigned to each said worker associated with said selected worker profiles.

25. The computer-implemented method of claim 24, wherein said workflow template characteristics comprise one or more of the following: a work mode template designation, a description of said work mode template, a task record priority mode, and a continuous mode option.

26. A computer-readable medium having instructions stored thereon for execution by a processor to perform a method for configuring one or more workflow templates used by a secretary of state or other government agency office, the method comprising:
displaying a plurality of workflow template characteristics;
receiving a plurality of workflow template characteristic selections corresponding to said workflow template characteristics; and
storing said workflow template characteristics and said workflow template characteristic selections in a data storage device so as to define a workflow template that specifies a workflow for a plurality of task records selected from the group consisting of lien task records, business entity task records, trademark task records, notary task records, and licensing task records.

27. The computer-readable medium of claim 26, wherein said method further comprises applying said workflow template to a worker profile, whereby said task records are assigned to at least one worker associated with said worker profile in accordance with said workflow template.

28. The computer-readable medium of claim 26, wherein said workflow template comprises an access template that specifies one or more task record types to be assigned to a worker.

29. The computer-readable medium of claim 28, wherein said workflow template characteristics comprise one or more of the following: an access template designation, one or more office designations, a description of said access template, a line of business in which said access template is used, an activation date, a deactivation date, one or more task record type characteristics, and an access level.

30. The computer-readable medium of claim 26, wherein said workflow template comprises a work mode template that specifies an order in which said task records are assigned to a worker and whether said task records are continuously assigned to said worker.

31. The computer-readable medium of claim 30, wherein said workflow template characteristics comprise one or more of the following: a work mode template designation, a description of said work mode template, a task record priority mode, and a continuous mode option.

32. The computer-readable medium of claim 26, wherein said method further comprises displaying one or more pre-determined options associated with at least one of said workflow template characteristics.

33. The computer-readable medium of claim 32, wherein at least one of said workflow template characteristic selections comprises a selection made by a user from said pre-determined options.

34. The computer-readable medium of claim 26, wherein said method further comprises displaying a text box associated with at least one of said workflow template characteristics.

35. The computer-readable medium of claim 34, wherein at least one of said workflow template characteristic selections comprises a text entry entered by a user in said text box.

36. The computer-readable medium of claim 26, wherein said method further comprises displaying a checkbox for at least one of said workflow template characteristics.

37. The computer-readable medium of claim 36, wherein at least one of said workflow template characteristic selections comprises a check entered by a user in said checkbox.

38. The computer-readable medium of claim 26, wherein said method further comprises displaying a summary of said workflow template.

39. The computer-readable medium of claim 38, wherein said summary of said workflow template comprises one or more of said workflow template characteristics and associated workflow template characteristic selections for said workflow template.

40. A computer-readable medium having instructions stored thereon for execution by a processor to perform a method for assigning task records to workers in a secretary of state or other government agency office, the method comprising:
displaying a plurality of workflow template characteristics;
receiving a plurality of workflow template characteristic selections corresponding to said workflow template characteristics:
storing said workflow template characteristics and workflow template characteristic selections so as to define one of a plurality of workflow templates each of which specifies a workflow for a plurality of task records selected from the group consisting of lien task records, business entity task records, trademark task records, notary task records, and licensing task records;
displaying a plurality of worker profiles each of which is associated with at least one worker;
receiving a selection of one or more of said displayed worker profiles;
displaying said workflow templates:
receiving a selection of one or more of said displayed workflow templates; and
applying said selected workflow templates to said selected worker profiles.

41. The computer-readable medium of claim 40, wherein said task records are assigned to each said worker associated with said selected worker profiles in accordance with said applied workflow templates.

42. The computer-readable medium of claim 40, wherein said method further comprises displaying said applied workflow templates in association with each of said worker profiles.

43. The computer-readable medium of claim 40, wherein said method further comprises removing one or more of said applied workflow templates from one or more of said worker profiles.

44. The computer-readable medium of claim 40, wherein one of said applied workflow templates comprises an access template that specifies one or more task record types to be assigned to each said worker associated with said selected worker profiles.

45. The computer-readable medium of claim 44, wherein said workflow template characteristics comprise one or more of the following: an access template designation, one or more office designations, a description of said access template, a line of business in which said access template is used, an activation date, a deactivation date, one or more task record type characteristics, and an access level.

46. The computer-readable medium of claim 40, wherein one of said applied workflow templates comprises a work mode template that specifies the order in which said task records are assigned to each said worker associated with said selected worker profiles and whether said task records are continuously assigned to each said worker associated with said selected worker profiles.

47. The computer-readable medium of claim 46, wherein said workflow template characteristics comprise one or more of the following: a work mode template designation, a description of said work mode template, a task record priority mode, and a continuous mode option.
